(19) United States
(12) Patent Application Publication
(10) Pub. No.: US 2019/0243873 A1
(43) Pub. Date: Aug. 8, 2019

(54) Enhanced Storytelling With Auto-Generated Content And Annotations

(71) Applicant: Microsoft Technology Licensing, LLC, Redmond, WA (US)

(72) Inventors: Chuma KABAGHE, Bellevue, WA (US); Chilumba MUBASHI, Redmond, WA (US); LeRoy F. MILLER, Tacoma, WA (US); Mark J. TALLEY, Bellevue, WA (US); Nicole A. WOON, Seattle, WA (US); Patrick S. DONOGHUE, Redmond, WA (US); Rowan T. FORSTER, Seattle, WA (US); Shawn C. CALLEGARI, Redmond, WA (US); Kwan-Yi CHAN, Bellevue, WA (US)

(21) Appl. No.: 15/887,621

(22) Filed: Feb. 2, 2018

(51) Int. Cl. G06F 17/21; G06F 17/30

(52) U.S. Cl. CPC G06F 17/212; G06F 17/30309; G06F 17/30525

(57) ABSTRACT

The background story behind the production of user-created content may include gathering information (suggestions) about conditions and events at points in time during the production process. In some instances, the information can be based on points in time in a history recorded during the content creation process. In some instances, the information can be collected or gathered in real-time during the content creation process. The gathered information can be combined with the user-created content at different points in time in the content creation process to generate elements used to create the background story.

### BACKGROUND

Often when sharing creative content, the story behind the process of creating the content can be as interesting as the content itself. However, the user is often on their own when it comes to this storytelling aspect.

Some basic example exist in most social media sharing today, such as adding location/time/people tags to shared content as well as a description. Apps like Microsoft and Google Photos will also group a selection of photos together automatically to create albums. Paint3D has a specific implementation where they will generate a video of the creation of a 3D object in the application.

### SUMMARY

In some embodiments according to the present disclosure, producing the background story behind user-created content can be facilitated by gathering and collecting suggestions for the background story at various points in time during the creation of the content. In some embodiments, the suggestions can be gathered at points in time based on a recorded history of the process of producing the user-created content. In other embodiments, the suggestions can be gathered during the content creation process.

Story elements for the background story can be created by associating suggestions with the user-created content. In some embodiments, for example, a theme or mood of the background story can be determined. Based on the theme or mood, different suggestions can be associated with the user-created content at different times during the creation process. The story elements can then be combined to produce the background story.

The following detailed description and accompanying drawings provide further understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified block diagram of a system environment according to some embodiments.

FIG. 2 shows details of the showbox creator in accordance with some embodiments.

FIG. 3 shows a high level flow of operations to create the background story creator in accordance with some embodiments.

FIGS. 4A and 4B illustrate and example of a timeline in accordance with some embodiments.

FIG. 5 shows an example of a user interface for producing a background story in accordance with some embodiments.

FIG. 6 depicts a simplified block diagram of a system environment according to some embodiments.

FIG. 7 depicts a simplified block diagram of an example computer system according to certain embodiments.

### DETAILED DESCRIPTION

In accordance with the present disclosure, the content creation process can be annotated with information to facilitate and otherwise support the production of a background story behind the process. In various embodiments, suggestion information can be gathered, for example, using a recorded history of the content creation process. Points in time in the history can be used to identify circumstances (conditions, events, etc.) surrounding the creator of the content. In some embodiments, the suggestions can be automatically gathered concurrently with the process of producing the user-created content. Building the background story can include determining a theme or mood of the story, and matching or otherwise associating relevant pieces of the collected suggestion information with the user-created content based on that theme or mood.

Embodiments of the present disclosure provide a technical solution to the challenge of gathering, maintaining, and managing suggestion information during the process of creating content. Embodiments in accordance with the present disclosure allow the content creator to focus on the creative aspects of producing their content, without the distraction of having to collect information (time, places, events) for a background story. This improves their efficiency in the task at hand, namely the creation of their content, by allowing the creator to stay focused on the creating their content; and in the subsequent task of producing the background story behind their efforts in creating the content by not having to remember where and when they were during the process. This can be especially significant when creation of the content can take place over a long period of time and in various locations. In some circumstances, multiple different applications involving various contributors can be involved in more sophisticated creations, which can further add to the challenge of creating the background story.

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

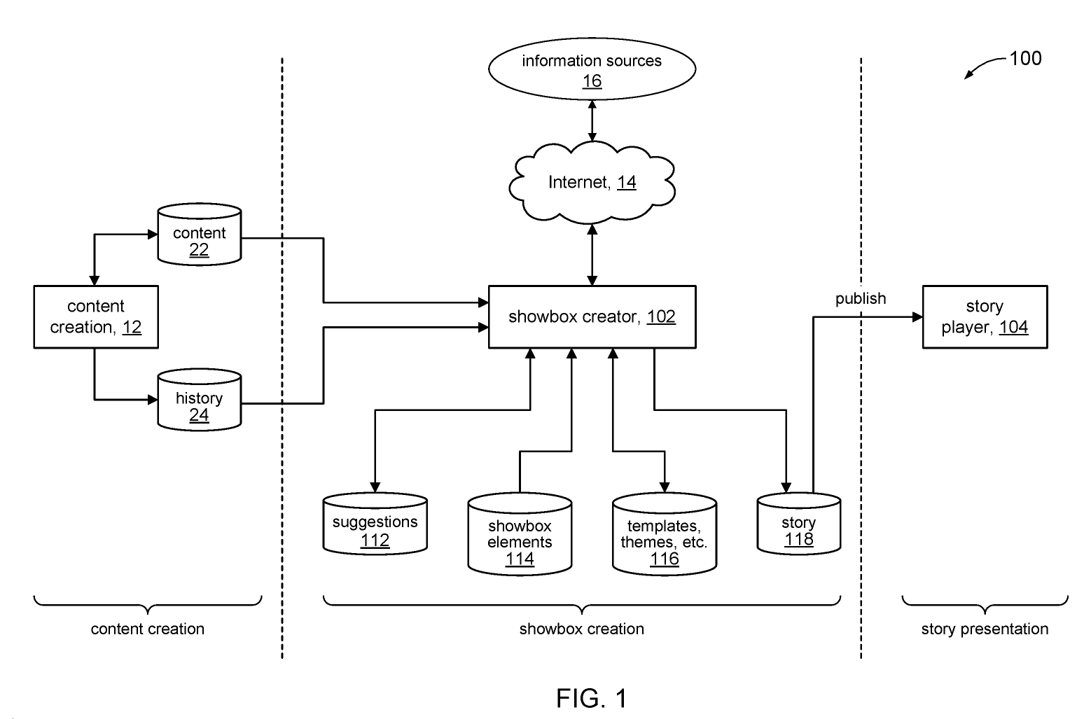

FIG. 1 shows an illustrative system 100 for creating a background story behind user-created content in accordance with the present disclosure. In some embodiments, for example, the system can include a content creation portion, a story creation portion, and story presentation.

At the content creation end of the process, one or more users can interact with content creation application 12 to produce user-created content 22. The content can be single-media or multi-media content, comprising any combination of text, graphics, animations, audio, video, and the like. The content creation application 12 represents any suitable application or applications for creating content, and can represent an infrastructure to support a suite of content creation applications. In some embodiments, the content creation application 12 can record and store a history 24 of the content creation process. The amount and kind of information contained in the history 24 will depend on the content creation application 12; e.g., its capabilities and how it is configured by the user. The history 24 may comprise instances of the content 22, for example, that is captured when the user performs a save operation or when an auto-save operation occurs. The history 24 may track changes made to objects comprising the content 22; for example, the Microsoft® Paint 3D™ 3D object modeling tool includes a feature called “lineage” that records changes made to 3D objects over the lifetimes of those objects.

Creation of the background story 118 can begin with the user-created content 22 and history 24. A showbox creator application 102 can import the content 22 and history 24 to generate information (referred to herein as suggestions 112) used to craft the story 118. The resulting story that is created can be referred to as a showbox. However as used herein, “showbox” can also be a descriptor that refers to any suitable data formats and object structures used for creating a story 118 in accordance with embodiments of the present disclosure.

As will be discussed in more detail below, the showbox creator 102 can generate suggestions 112 by accessing information sources 16, for example, over the Internet 14 and/or any other information network. In accordance with the present disclosure, suggestions 112 represent circumstances surrounding the process of producing the content 22. The suggested information are “suggestions” in the sense that the showbox creator 102 can autonomously generate such information, rather than being generated under the direction of a user. The suggestions 112 can include events that occur and conditions that exist at various times during the production of the content 22. In some embodiments, for example, the events and conditions can relate to the subject matter of the content 22 itself. Such information can be indicative of circumstances that influence the production of the content 22. In other embodiments in accordance with the present disclosure, suggestions 112 can comprise events and conditions that are unrelated to the subject matter of the content 22, but may server to provide a more complete story behind the process of producing the content 22 or to provide context to the story.

The showbox creator 102 can generate showbox elements 114, which comprise pieces of information in the suggestions 112 associated with the state of the user-created content 22 at various points in time during the process of producing the content. The showbox elements 114 can serve as the starting points or raw data for the story creation process, which will be discussed further below.

The showbox creator 102 can import filters 116 such as templates, themes, etc. to sort through the showbox elements 114 during the story creation process. These can be predefined elements, for example, created by the user, and used to provide a framework for creating the background story 118. The showbox creator 102 can provide a suitable interface that allows a user to participate in the story creation process.

The story 118 can be published and presented using a suitable story player 104. In some embodiments, for example, the story 118 can be published as a showbox file and played back using a showbox application. In other embodiments the story 118 can be accessed and played back online, for example, on a showbox-enabled website. In some embodiments, the story 118 can be rendered using any suitable data format.

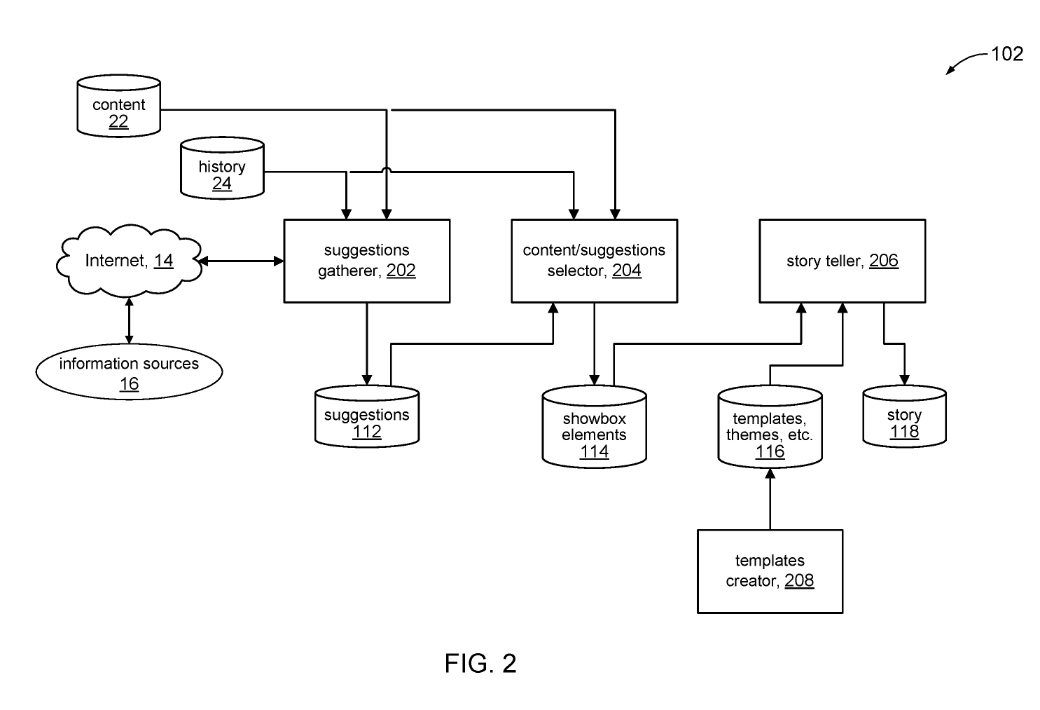

FIG. 2 shows details for the showbox creator application 102 in accordance with some embodiments. In particular, various functional modules comprising the showbox creator 102 are described. Details of processing in the modules are discussed below.

The showbox creator 102 can include a suggestions gatherer 202, which accesses information sources 16 (e.g., via the Internet 14) to gather suggestions 112. In some embodiments, the suggestions gatherer 202 can import the user-created content 22 and the history 24 as inputs to the suggestion gathering process.

The showbox creator 102 can include a content/suggestions selector 204 that combines pieces of the content 22 with different pieces of suggestions 112 to create showbox elements 114. In some embodiments, for example, the content/suggestions selector 204 can be an automated process to match content with suggestions. In other embodiments, the content/suggestion matching can include interactions with the user to direct the matching process, to modify suggestions that have been with content, and so on.

The showbox creator 102 can include a story teller 206 that combines the showbox elements 114 to create a story 118. In some embodiments, the story teller 206 can use predefined templates, themes, and so on 116 to direct the story telling process. In some embodiments, story creation can be an automated process, and in other embodiments can include interactions with a user.

The showbox creator 102 can include a templates creator 208 to create the templates, themes, etc. 116 used to direct the story telling process.

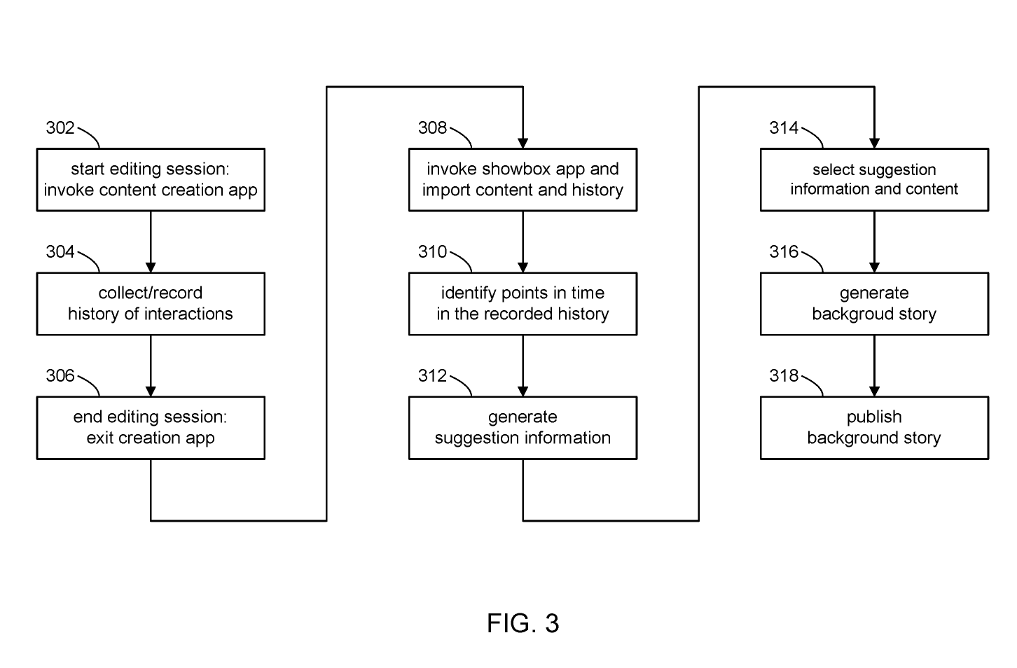

Referring to FIGS. 3, 4A, 4B, and 5, the discussion will now turn to a high level description of processing in the content creator (e.g., 12, FIG. 1) and showbox creator (e.g., 102, FIG. 1) to produce the background story behind the production of user-create content in accordance with the present disclosure. In some embodiments, for example, the content creator and showbox creator can include computer executable program code, which when executed by respective computer systems in the content creator and showbox creator, can cause the computer systems to perform the processing in accordance with FIG. 3. The processing is not necessarily limited to the order of operations shown.

At operation 302, the user (e.g., content creator) can invoke a suitable application (e.g., word processing, graphics rendering, audio-visual production, etc.) to begin an editing session to produce user-created content.

At operation 304, the content creation application can record a history (e.g., 24, FIG. 1) of user interactions and events (milestones) during the process of content creation. For example, an application may be configured to perform periodic auto-save operations to create intermediate versions of the content. Each auto-save operation can be a milestone in the history. The Microsoft® Paint 3D™ 3D object modeling tool mentioned above includes a feature called “lineage” that records changes made to 3D objects over the lifetimes of those objects, including changes made by others and imported by the creator. Each recorded change in the object can serve as a milestone in the history. In some embodiments, the content creation application can create history having even more detail, for example, by recording certain keystrokes, mouse inputs, menu selections and so on that the user makes during their editing session. The history can include various metadata relating to the content being created, for example, creation date, document size, word count, object count, and the like.

At operation 306, the user can exit the content creation application, thus ending an editing session with the application. The user may engage in several sessions during the content creation process, with each session adding to the recorded history. In some embodiments, the content creation process can include several different tools for creating the content. An interaction history can be recorded with each tool. The individual histories can be combined into or otherwise accessed as a single recorded history.

At operation 308, the user can invoke the showbox creator to generate a background story behind the process of producing the user-created content. The showbox creator can import the user-created content and the recorded history as inputs to the process.

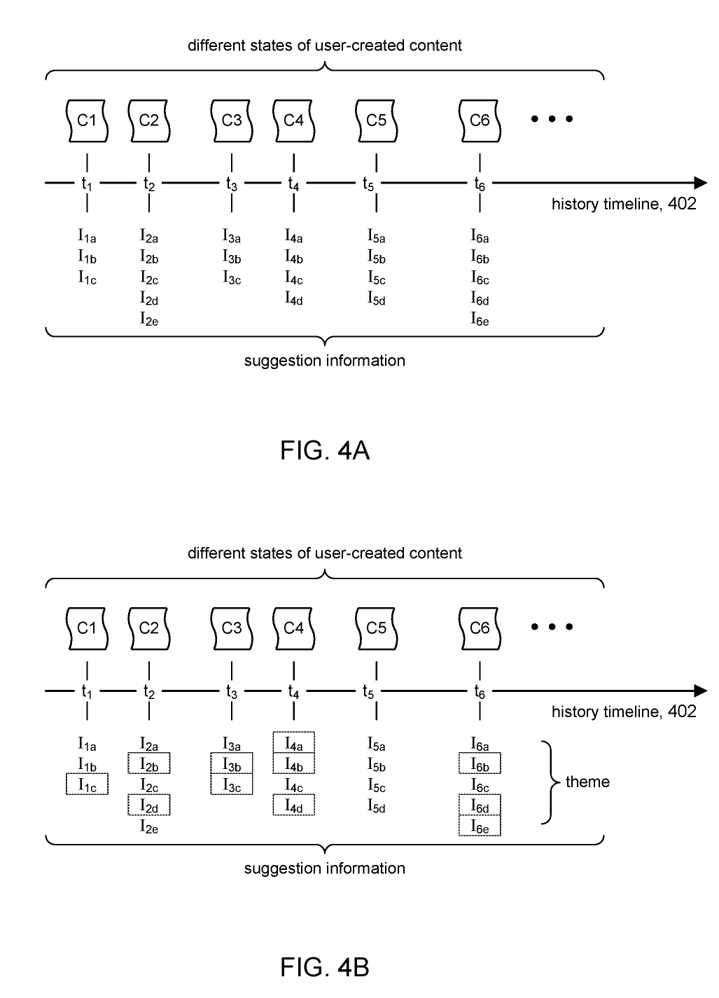

At operation 310, the showbox creator can identify points in time during the process of producing the user-created content. For example, the showbox creator can use the various milestones in the recorded history as points in times. In some instances, the points in time may be fixed points in time in the history. For example, every minute (five minutes, ten minutes, etc.) along the timeline of the recorded history can serve as a point in time. FIG. 4A, for example, illustrates an example of a timeline 402 with points in time t₁ through t₆.

At operation 312, the showbox creator can gather suggestion information (suggestions) based on the points in time identified above, which can be used to create the background story. Suggestions can provide further context to the process of producing the user-created content, in addition to the recorded history. In some embodiments, for example, the showbox creator can access various information sources (e.g., search engines, news sources/feeds, blogs, etc.) to identify and access events occurring at the identified points in time. The showbox creator can use state of the user-created content at each point in time to identify subject matter as a basis for searching the information sources to provide suggestions that may be relevant to the content-creating process. More generally, the showbox creator can access information based only on time to gather any information as suggestions, independent of the context of the user-created content. FIG. 4A, for example, shows various pieces of suggestion information gathered at each point in time t₁ through t₆.

At operation 314, the showbox creator can generate showbox elements as the basis for generating the background story. The showbox elements that are generated can be based on a theme or mood of the background story. In some embodiments, for example, the showbox creator can use algorithms to identify the theme or mood of the creation based on the subject matter of the user-created content. In some embodiments, the user can direct the process of selecting the theme.

Showbox elements can comprise associations between suggestions and different states of the user-created content along the timeline of the recorded history. In some embodiments, for example, the showbox creator can identify pieces of suggestion information that are relevant to the selected theme or mood, and associate the selected pieces of information with the user-created content at each point in time. FIG. 4B, for example, illustrates an example showing various pieces of information along the timeline 402 having been identified as relevant for a given theme. Thus, for example, a showbox element at time t₁ may comprise the content C1 associated with information I_{1c}. The showbox element at time t₂ may comprise the content C2 associated with information pieces I_{2b} and I_{2d}, and so on.

The resulting showbox elements can then serve as basic story elements of a background story for a given theme or mood. In some embodiments, the showbox creator can automatically generate the showbox elements. The user can then access and make adjustments to the showbox elements to fine tune the suggestion information that is associated with the content.

As an example, a showbox element can be a time sequence that combines content and suggestion information gathered across a span of time in the history, referred to as a “timelapse” object. In some embodiments, for example a timelapse object can utilize the auto-save and backup/restore functionality that is built into some content creation applications, combined with some relevant statistics (metadata), to automatically generate a stylized timelapse of the creation. In a text editing application, for instance, each auto-save (or a regular save) operation can record metadata such as: word count, page count, timestamp, contributors, and the like. The timelapse object can be incorporated in the background story as a graph to illustrate the creator's progress over time in terms of the number of words in the document.

As another example, consider the Paint 3D™ object modeling tool mentioned above. The application supports a feature called “lineage” where a 3D object's life is tracked and recorded, including subsequent “remixes” by different users. In some embodiments, the data points in the lineage can be collected in a showbox element to represent a stylized “timeline”, showing where the object started, who created it, who made it edits, and when. The user can then incorporate this timeline object into their background story.

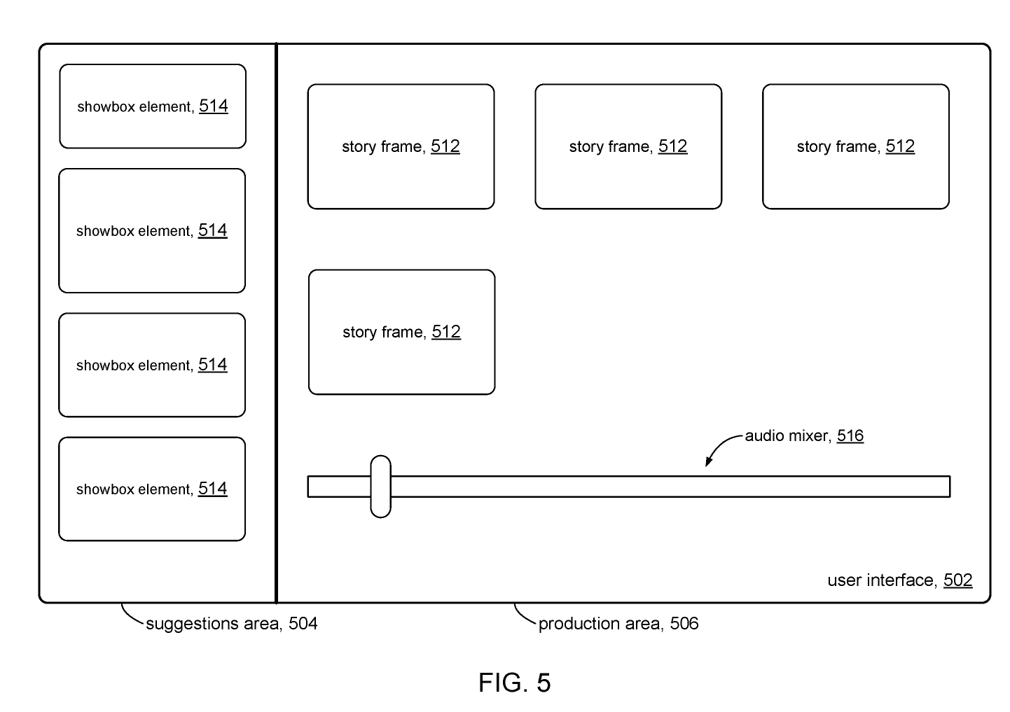

At operation 316, the showbox creator can facilitate the user in generating the background story. FIG. 5, for example, illustrates a user interface (UI) 502 in accordance with some embodiments for producing the background story. The UI 502 can include a suggestions area 504 to present a list of showbox elements 514, for example, generated at operation 314. The UI 502 can include a production area 506 to allow a user to create frames 512 that comprise the background story. The user can select showbox elements 514 and incorporate them into the frames 512. The UI 502 can include an audio mixer 516 to add a soundtrack to the background story. The soundtrack can comprise audio contained in the showbox elements 514. The user can record their own audio (e.g., a narrative) to incorporated into the story. The showbox creator can then combine the frames 512 and recorded audio to produce a video presentation of the background story.

At operation 318, the user can publish the resulting background story to share their experience in the production of their content. Content comprising the background story can be formatted using a known data format (e.g., Windows Media Video, MPEG, Flash Video, etc.), or a proprietary data format. Published stories can be viewed using an appropriate player. In some embodiments, the story can be published to and hosted on a server and viewed online (e.g., youtube.com, vimeo.com), shared on social media websites, and so on.

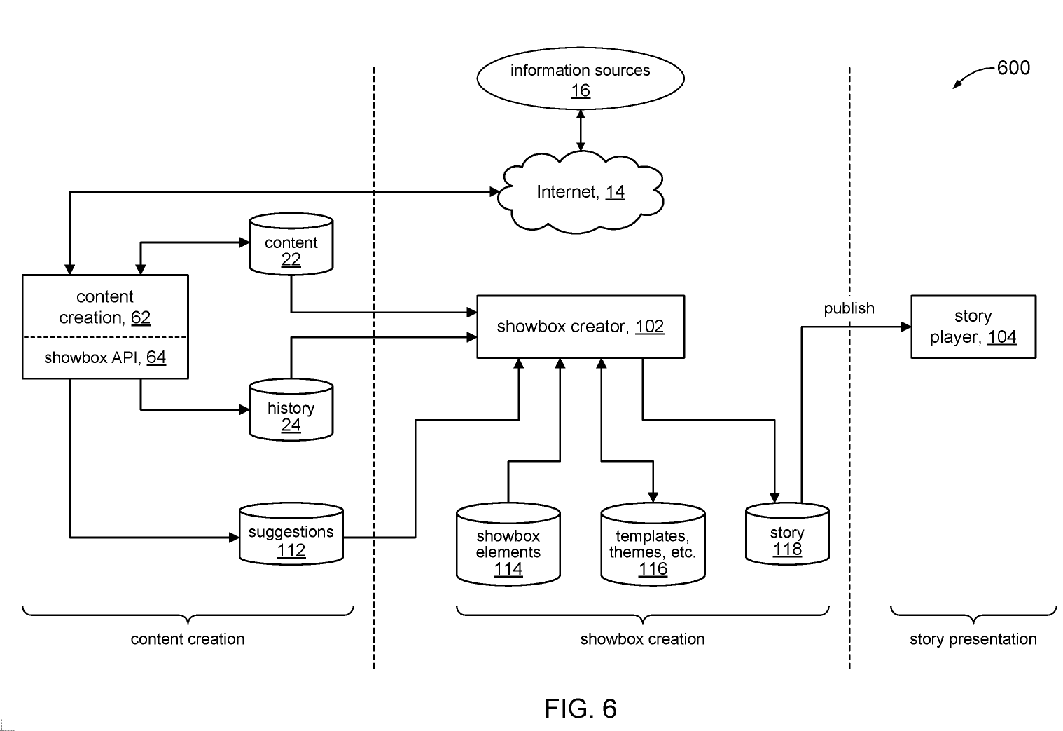

FIG. 6 shows an illustrative system 600 process for creating a background story behind user-created content in accordance with the present disclosure. In some embodiments, the system can include a content creation portion, a story creation portion, and story presentation.

In some embodiments, the content creation application 62 can include a showbox application programming interface (API) 64 to access functionality in the showbox creator 102, and in particular the suggestions gathering functionality. By integrating the suggestions gathering functionality with the content creation application 62, a more robust set of suggestions 112 can be gathered during production of the content 22 because the information can be collected in real-time as transient events and conditions happen around the user. Thus, as the user changes their location from one editing session to another during the production of their content, the suggestions that are gathered can reflect the times and locations of those editing sessions.

In some embodiments, for example, suggestions can include location-specific conditions surrounding the user such as their geographical location, local weather conditions (e.g., from the Internet), and so on. Global positioning satellite (GPS) information can be used to identify the user's location. Local events can be captured. In some embodiments, the events may be related to the subject matter of the content being created and in other embodiments the events may not necessarily relate to the content. Suggestions based on geocaching type information can be collected. For example, items or people proximate the user's location can be recorded as suggestions. Such location-specific conditions and events can be combined with the user-created content to create showbox elements 114 referred to as “setting” objects which can provide a rich experience describing the circumstances surrounding the creation.

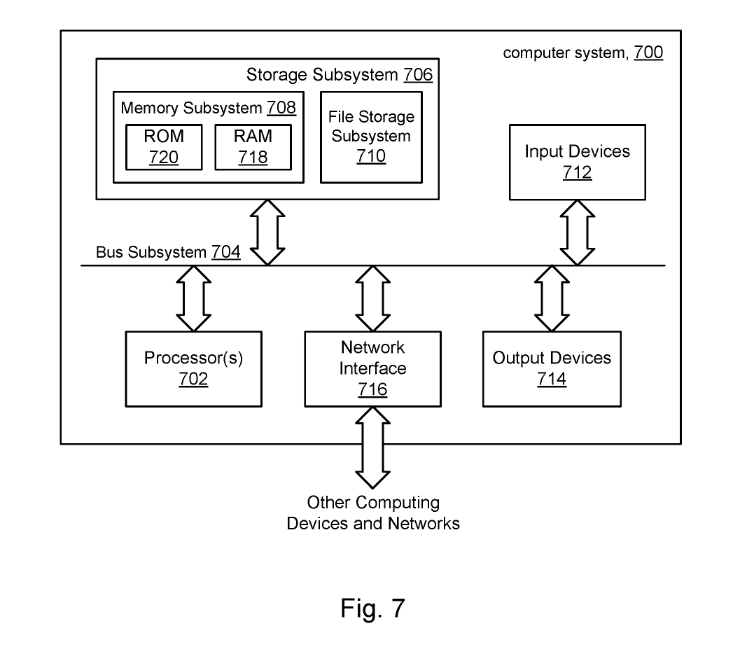

FIG. 7 depicts a simplified block diagram of an example computer system 700 according to certain embodiments. Computer system 700 can be used to implement any of the computing devices, systems, or servers described in the foregoing disclosure. As shown in FIG. 7, computer system 700 includes one or more processors 702 that communicate with a number of peripheral devices via a bus subsystem 704. These peripheral devices include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks. Embodiments of network interface subsystem 716 can include, e.g., an Ethernet card, a WiFi and/or cellular adapter, a modem (telephone, satellite, cable, ISDN, etc.), digital subscriber line (DSL) units, and/or the like.

User interface input devices 712 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 700.

User interface output devices 714 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 700.

Storage subsystem 706 includes a memory subsystem 708 and a file/disk storage subsystem 710. Subsystems 708 and 710 represent non-transitory computer-readable storage media that can store program code and/or data that provide the functionality of embodiments of the present disclosure.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

1. Apparatus for annotating user-created content, the apparatus comprising:
one or more computer processors; and
a computer-readable storage medium comprising instructions for controlling the one or more computer processors to be operable to:
identify points in time in a process of producing the user-created content;
autonomously generate suggested information relating to conditions and events that are concurrent with the identified points in time in the process;
autonomously associate pieces of the suggested information with the user-created content at one or more of the identified points in time in the process to enhance the user-created content with context that describes circumstances surrounding the process of producing the user-created content; and
use the context-enhanced user-created content to generate a background story behind the process of producing the user-created content.

2. The apparatus of claim 1, wherein the computer-readable storage medium further comprises instructions for controlling the one or more computer processors to be operable to obtain metadata that describes the user-created content at one or more of the identified points in time.

3. The apparatus of claim 1, wherein the computer-readable storage medium further comprises instructions for controlling the one or more computer processors to be operable to access information from one or more information sources that is based on subject matter comprising the user-created content to produce the suggested information.

4. The apparatus of claim 1, wherein generating suggested information relating to conditions and events that are concurrent with the identified points in time includes, for each identified point in time:
accessing one or more information sources to identify events that are concurrent with the identified point in time;
accessing the one or more information sources to identify conditions that exist at the identified point in time;
identifying a location where the process of producing the user-created content is performed; and
identifying people and/or items in the vicinity where the process of producing the user-created content is performed.

5. The apparatus of claim 4, wherein the conditions and events are based on subject matter comprising the user-created content.

6. The apparatus of claim 1, wherein the computer-readable storage medium further comprises instructions for controlling the one or more computer processors to be operable to perform the identifying and generating operations as a process separate from and subsequent to the process of producing the user-created content.

7. The apparatus of claim 6, wherein the computer-readable storage medium further comprises instructions for controlling the one or more computer processors to be operable to perform the identifying operation using a recorded history of the process of producing the user-created content, wherein the points in time are time indices in the recorded history.

8. The apparatus of claim 1, wherein the computer-readable storage medium further comprises instructions for controlling the one or more computer processors to be operable to perform the identifying and generating operations during the process of producing the user-created content.

9. A method for annotating user-created content, the method comprising:
identifying points in time in a process of producing the user-created content;
autonomously generating suggested information relating to conditions and events that are concurrent with the identified points in time in the process;
autonomously associating pieces of the suggested information with the user-created content at one or more of the identified points in time in the process to enhance the user-created content with context that describes circumstances surrounding the process of producing the user-created content; and
using the context-enhanced user-created content to generate a background story behind the process of producing the user-created content.

10. The method of claim 9, further comprising obtaining metadata that describes the user-created content at one or more of the identified points in time.

11. The method of claim 9, further comprising accessing information from one or more information sources that is based on subject matter comprising the user-created content to produce the suggested information.

12. The method of claim 9, wherein generating suggested information relating to conditions and events that are concurrent with the identified points in time includes, for each identified point in time:
accessing one or more information sources to identify events that are concurrent with the identified point in time;
accessing the one or more information sources to identify conditions that exist at the identified point in time;
identifying a location where the process of producing the user-created content is performed; and
identifying people and/or items in the vicinity where the process of producing the user-created content is performed.

13. The method of claim 12, wherein the conditions and events are based on subject matter comprising the user-created content.

14. The method of claim 9, further comprising performing the identifying and generating operations as a process separate from and subsequent to the process of producing the user-created content.

15. The method of claim 14, further comprising performing the identifying operation using a recorded history of the process of producing the user-created content, wherein the points in time are time indices in the recorded history.

16. The method of claim 9, further comprising performing the identifying and generating operations during the process of producing the user-created content.

17. A computer-readable storage medium having stored thereon computer executable instructions, which when executed by a computer device, cause the computer device to:
identify points in time in a process of producing the user-created content;
autonomously generate suggested information relating to conditions and events that are concurrent with the identified points in time in the process;
autonomously associate pieces of the suggested information with the user-created content at one or more of the identified points in time in the process to enhance the user-created content with context that describes circumstances surrounding the process of producing the user-created content; and
use the context-enhanced user-created content to generate a background story behind the process of producing the user-created content.

18. The computer-readable storage medium of claim 17, wherein the computer executable instructions, which when executed by the computer device, further cause the computer device to obtain metadata that describes the user-created content at one or more of the identified points in time.

19. The computer-readable storage medium of claim 17, wherein generating suggested information relating to conditions and events that are concurrent with the identified points in time includes, for each identified point in time:
accessing one or more information sources to identify events that are concurrent with the identified point in time;
accessing the one or more information sources to identify conditions that exist at the identified point in time;
identifying a location where the process of producing the user-created content is performed; and
identifying people and/or items in the vicinity where the process of producing the user-created content is performed.

20. The computer-readable storage medium of claim 17, wherein the computer executable instructions, which when executed by the computer device, further cause the computer device to perform the identifying and generating operations as a process separate from and subsequent to the process of producing the user-created content.
